(19) United States
(12) Patent Application Publication
(10) Pub. No.: US 2025/0085676 A1
(43) Pub. Date: Mar. 13, 2025

(54) DEVICE CONTROL METHOD, APPARATUS AND SYSTEM, AND ELECTRONIC DEVICE AND STORAGE MEDIUM

(71) Applicant: Lumi United Technology Co., Ltd., Shenzhen (CN)

(72) Inventors: Jing LU, Shenzhen (CN); Jiabo YANG, Shenzhen (CN)

(73) Assignee: Lumi United Technology Co., Ltd., Shenzhen, GD (CN)

(21) Appl. No.: 18/728,465

(22) PCT Filed: Jan. 12, 2023
(86) PCT No.: PCT/CN2023/071883

§ 371 Date: Jul. 12, 2024

(30) Foreign Application Priority Data
Jan. 12, 2022 (CN) 202210033013.3

(51) Int. Cl. G05B 15/02; G06F 9/451

(52) U.S. Cl. CPC G05B 15/02; G06F 9/451

(57) ABSTRACT

A device control method, comprising: displaying a device control interface corresponding to a scenario picture of a target scenario; in the device control interface, displaying a control assembly corresponding to at least one target device in the target scenario, wherein the control assembly is bound to a target device which is identified on the basis of an image in the target scenario; and in response to a control operation which is triggered for the control assembly, sending a corresponding control instruction to the target device, which corresponds to the control assembly, so as to control the target device to execute the control instruction.

The present application claims priority of Chinese patent application submitted to State Intellectual Property Office of P.R. China on Jan. 12, 2022, with an application number 202210033013.3 and a title “DEVICE CONTROL METHOD, APPARATUS AND SYSTEM, AND ELECTRONIC DEVICE AND STORAGE MEDIUM”, the entire content of which is incorporated into the present application by reference.

### TECHNICAL FIELD

The present application relates to the technical field of Internet of Things, in particular to a device control method, an apparatus, a system, an electronic device, and a storage medium.

### BACKGROUND

With the development of Internet of Things technology, intelligent control of devices has been increasingly applied in daily life. For example, in smart homes, users can control smart devices through terminals and achieve comprehensive information exchange functions. At present, in related technologies, when controlling a smart device through terminals, a user needs to find a smart device to be controlled in a smart home application, enter a control interface of the smart device, and then control the smart device through the control interface. However, when controlling the smart device in this way, the user needs to perform a lot of operations, which affects the user's experience.

### SUMMARY OF THE DISCLOSURE

### Technical solutions

A device control method, wherein the method comprises: showing a device control interface corresponding to a scenario picture of a target scenario; in the device control interface, displaying a control component corresponding to at least one target device in the target scenario, wherein the control component is bound to a target device identified in an image based on the target scenario; and in response to a control operation triggered for the control component, sending a corresponding control instruction to the target device corresponding to the control component, so as to control the target device to execute the control instruction.

A device control method, wherein the method comprises: performing target identification for an image collected in a target scenario to obtain a target device in the image; acquiring devices that have been added in the target scenario and matching the target device in the image with the devices that have been added; and if there is a device that has been added matching with the target device, binding the target device with a control component corresponding to the matching device that has been added in a device control interface corresponding to a scenario picture of the target scenario, wherein the control component is configured to control the target device in the device control interface.

A device control system comprising a terminal and a server; wherein the server is configured to: perform target identification for an image collected in a target scenario to obtain a target device in the image; acquire devices that have been added in the target scenario and match the target device in the image with the devices that have been added; if there is a device that has been added matching with the target device, bind the target device with a control component corresponding to the matching device that has been added in a device control interface corresponding to a scenario picture of the target scenario, wherein the control component is configured to control the target device in the device control interface; the terminal is configured to: show the device control interface corresponding to the scenario picture of the target scenario; in the device control interface, display a control component corresponding to at least one target device in the target scenario, wherein the control component is bound to a target device identified based on an image in the target scenario; and in response to a control operation triggered for the control component, send a corresponding control instruction to the target device corresponding to the control component, so as to control the target device to execute the control instruction.

A device control apparatus, wherein the apparatus comprises: an interface showing module configured to show a device control interface corresponding to a scenario picture of a target scenario; a control component displaying module configured to: in the device control interface, display a control component corresponding to at least one target device in the target scenario, wherein the control component is bound to a target device identified based on an image in the target scenario; and an instruction sending module configured to: in response to a control operation triggered for the control component, send a corresponding control instruction to the target device corresponding to the control component, so as to control the target device to execute the control instruction.

In an embodiment thereof, the control component displaying module comprises: a first displaying unit configured to display a scenario picture corresponding to a real target scenario in the device control interface; and a second displaying unit configured to display, in the scenario picture, a control component corresponding to at least one target device in the real target scenario.

In an embodiment thereof, the apparatus further comprises: a device status entrance displaying module configured to display a device status entrance corresponding to the target device in the control component; and a device status information displaying module configured to show current device status information corresponding to the target device in response to a trigger operation for the device status entrance.

In an embodiment thereof, the apparatus further comprises: a device status information updating module configured to dynamically update the device status information in the device control interface when identifying that the device status information of the target device generates change based on an image collected in the target scenario.

In an embodiment thereof, the device control interface comprises a scenario picture of a two-dimensional target scenario or a scenario picture of a three-dimensional target scenario corresponding to a real scenario.

A device control apparatus, wherein the apparatus comprises: a target identification module configured to perform target identification for an image collected in a target scenario to obtain a target device in the image; a device matching module configured to acquire devices that have been added in the target scenario and match the target device in the image with the devices that have been added; and a binding module configured to: if there is a device that has been added matching with the target device, bind the target device with a control component corresponding to the matching device that has been added in a device control interface corresponding to a scenario picture of the target scenario, wherein the control component is configured to control the target device in the device control interface.

In an embodiment thereof, the target identification module comprises: an image acquiring unit configured to acquire the image collected in the target scenario; and a target identification unit configured to perform target identification for the image to obtain a device type corresponding to the target device in the image and a device position of the target device in the target scenario; the device matching module comprises: a device information acquiring unit configured to acquire device types and device positions of the devices that have been added in the target scenario; and a device matching unit configured to match the device type and the device position of the target device with the device types and the device positions of the devices that have been added.

In an embodiment thereof, the device matching unit is configured to: in the devices that have been added, determine target added devices of which device positions match with the device position of the target device; and in the target added devices, determine a device of which the device type matches with the device type of the target device as the device that has been added matching with the target device.

In an embodiment thereof, the target device in the image is obtained by performing identification through a trained deep learning model; the trained deep learning model is obtained through model training steps; the apparatus comprises a model training module, and the model training module comprises: a sample image acquiring unit configured to acquire sample images collected in multiple kinds of real environments, wherein the sample images comprise sample labels labeled with positions and types of sample target devices; a target identification unit configured to perform target identification for the sample images through an initial deep learning model to obtain an identification result of a sample target device in the sample images, wherein the identification result comprises a position and a type of the sample target device; and a training unit configured to adjust parameters of the initial deep learning model based on difference between the identification result and the sample labels and continue to train, and stop training when training conditions are met to obtain the trained deep learning model.

An electronic device comprising a processor, a memory, and computer readable instructions stored in the memory and being capable of running in the processor, wherein the computer readable instructions are executed by the processor to implement the following steps: showing a device control interface corresponding to a scenario picture of a target scenario; in the device control interface, displaying a control component corresponding to at least one target device in the target scenario, wherein the control component is bound to a target device identified in an image based on the target scenario; and in response to a control operation triggered for the control component, sending a corresponding control instruction to the target device corresponding to the control component, so as to control the target device to execute the control instruction.

One or more non-volatile computer readable storage medium storing computer readable instructions, wherein the computer readable instructions, when being executed by one or more processor, make the one or more processor to execute the following steps: showing a device control interface corresponding to a scenario picture of a target scenario; in the device control interface, displaying a control component corresponding to at least one target device in the target scenario, wherein the control component is bound to a target device identified in an image based on the target scenario; and in response to a control operation triggered for the control component, sending a corresponding control instruction to the target device corresponding to the control component, so as to control the target device to execute the control instruction.

Details of one or more embodiments in the present application are presented in the accompanying drawings and description below. Other features, purposes, and advantages of the present application will become apparent from the specification, drawings, and claims.

### BRIEF DESCRIPTION OF THE DRAWINGS

In order to illustrate technical solutions in embodiments of the present application more clearly, drawings required to be used in description of the embodiments will be briefly introduced below. Obviously, the drawings in the following description are only some embodiments of the present application. For ordinary technical personnel in this field, other drawings can be further obtained based on these drawings on the premise of paying no creative labor.

FIG. 1 is an application environment diagram of a device control method provided by an embodiment of the present application.

FIG. 2 is a schematic flow chart of a device control method provided by an embodiment of the present application.

FIG. 3 is a schematic view of a device control interface provided by an embodiment of the present application.

FIG. 4 is a schematic view of a position of a target device in a scenario picture provided by an embodiment of the present application.

FIG. 5 is a schematic flow chart of a device control method provided by another embodiment of the present application.

FIG. 6 is a schematic flow chart of matching a target device with a device that has been added provided by an embodiment of the present application.

FIG. 7 is a schematic flow chart of a device control method provided by further another embodiment of the present application.

FIG. 8 is a structural block diagram of a device control system provided by an embodiment of the present application.

FIG. 9 is a structural block diagram of a device control apparatus provided by an embodiment of the present application.

FIG. 10 is a structural block diagram of a device control apparatus provided by another embodiment of the present application.

FIG. 11 is an internal structural diagram of an electronic device provided by an embodiment of the present application.

FIG. 12 is an internal structural diagram of an electronic device provided by another embodiment of the present application.

### DETAILED DESCRIPTION

In order to make purposes, technical solutions, and advantages of the present application be clearer and more understandable, the present application is further illustrated in detail below in accompany with drawings and embodiments. It should be understood that the specific embodiments described here are only intended to explain the present application, but not intended to limit the present application.

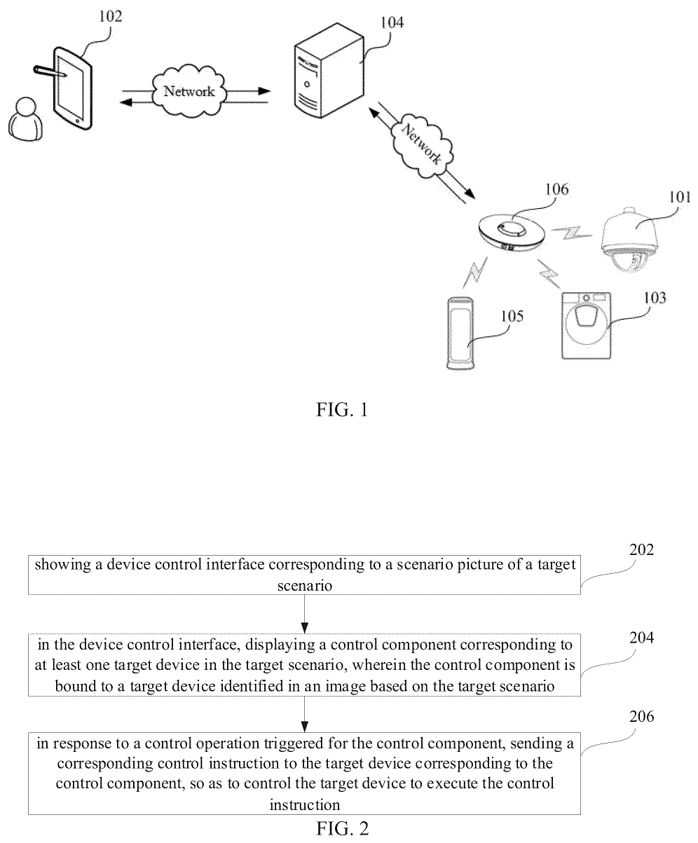

A device control method provided by the present application can be applied in an application environment as shown in FIG. 1. Among them, a terminal 102 communicates with a server 104 through a network, the server 104 communicates with a gateway 106 through the network, and Internet of Things (IOT) devices access the gateway 106 through a local area network. The IOT devices includes a camera 101, and can also include an intelligent washing machine 103, an intelligent air conditioning 105, a curtain motor, and other equipment, which are not limited here. The terminal 102 can show a device control interface corresponding to a scenario picture of a target scenario, and display a control component corresponding to at least one target IOT device in the device control interface; and the terminal 102, in response to a control operation triggered by a user for the control component, sends a corresponding control instruction to the target IOT device corresponding to the control component, so as to control the target IOT device to execute the control instruction.

The terminal 102 can send the control instruction to the gateway 106 through the network and the server 104, thereby realizing remote control for the IOT devices. In actual implementation, when the terminal 102 accesses the local area network where the gateway 106 is located, it can also directly send the control instruction to the gateway 106 through the local area network, thereby realizing control for the IOT devices. Among them, the terminal 102 may be, but is not limited to, various personal computers, notebook computers, smartphones, tablets, and portable wearable devices. The server 104 can be implemented using an independent server or a server cluster composed of multiple servers.

As shown in FIG. 2, a device control method is provided, the method can be applied in the terminal in FIG. 1, and includes the following steps.

Step 202, showing a device control interface corresponding to a scenario picture of a target scenario.

Among them, the target scenario refers to a scenario where device control is required, which can specifically be an environment with target devices mounted, for example, it can be a bedroom, a living room, overall layout, an office, and other environments. The target devices refer to devices in the target scenario that can access a network for communication and control, and can specifically be smart devices mounted in the target scenario, for example, they can include smart home devices, such as cameras, smart lights, smart curtains, smart air conditioning, smart TVs, door and window sensors, and other devices. The scenario picture refers to a picture that can reflect a status of the target scenario, and can specifically be a real picture or a virtual picture that reflects the target scenario. The real picture can be obtained based on images collected by an image collecting module, and the virtual picture can be obtained by modeling the for target scenario. The device control interface refers to an interface used to control the target device in the target scenario, in the device control interface, a two-dimensional scenario picture or a three-dimensional scenario picture corresponding to a real target scenario can be included.

Among them, the image collecting module, for example, is a camera that has been accessed the local area network where the gateway is located, which can be mounted in a living room, a bedrooms, a balcony, and other locations, and can capture images containing the target device. The images collected by the image collecting module can be sent to the terminal through the server. When the terminal accesses the local area network where the gateway is located, the images collected by the image collecting module can also be directly sent to the terminal through the gateway.

Step 204, in the device control interface, displaying a control component corresponding to at least one target device in the target scenario, wherein the control component is bound to a target device identified in an image based on the target scenario.

Among them, the control component is a control component that has accessed the local area network where the gateway is located; there is pre-configured binding relationship between the control component and a corresponding target device, so that the corresponding target device can be controlled. For example, if a wireless switch controls a lamp, the target device is the lamp, and the control component is the wireless switch. The control component can be a physical switch of the target device, and can also be a virtual switch of the target device, the virtual switch can be created in a home application; and the control component is displayed in the device control interface in a manner of an operation control, so as to receive control operations.

Step 206, in response to a control operation triggered for the control component, sending a corresponding control instruction to the target device corresponding to the control component, so as to control the target device to execute the control instruction.

Among them, after the control component in the device control interface receive a control operation, the terminal generates a corresponding control instruction; the control instruction can be sent to the gateway through the server to implement control for the target device. After the terminal accesses the local area network where the gateway is located, the control instruction can also be directly sent to the gateway to implement control for the target device.

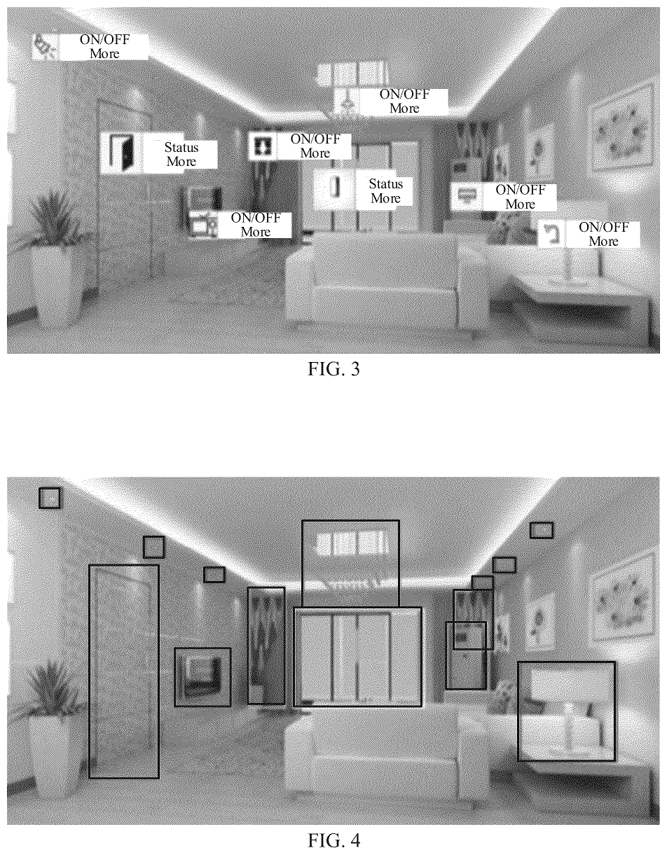

A schematic view of a device control interface displayed in a terminal is as shown in FIG. 3. The corresponding target scenario in the figure is a living room, and the scenario picture is a two-dimensional scenario picture. In the device control interface, there are multiple target devices such as smart curtains, smart air conditioners, smart lighting fixtures, etc. Corresponding control components are displayed next to the target devices and can perform operation such as on/off and others. In this way, by showing the device control interface corresponding to the scenario picture of the target scenario and displaying the control components bound to the target devices in the interface, it is realized that the smart devices in the scenario picture “can be controlled as seen”, users do not need to select control interfaces of the smart devices by multiple operations. Multiple target devices can be controlled on one interface, the operation is more convenient and more intuitive, greatly improving users' experience.

In the above device control method, by showing the device control interface corresponding to the scenario picture of the target scenario and displaying the control components bound to the target devices in the interface, it is realized that the smart devices in the scenario picture “can be controlled as seen”, users do not need to select control interfaces of the smart devices by multiple operations. The operation is more convenient, greatly improving users' experience.

In one embodiment, the in the device control interface, displaying a control component corresponding to at least one target device in the target scenario includes: displaying a scenario picture corresponding to a real target scenario in the device control interface; and displaying, in the scenario picture, a control component corresponding to at least one target device in the real target scenario.

Among them, positions of target devices in a scenario picture are as labeled in the blocks in FIG. 4, positions of control components displayed in the scenario picture are the positions in the scenario picture where the target devices are located or ambient regions of the located positions, such that the control components can be stacked and displayed on corresponding target devices or displayed beside corresponding target devices, as shown in FIG. 3, it can be more convenient for users to quickly control corresponding target devices.

In one embodiment, the method further includes the following steps: displaying a device status entrance corresponding to the target device in the control component; and showing current device status information corresponding to the target device in response to a trigger operation for the device status entrance.

Among them, the current device status information refers to current status information of the target device, for example, for a smart curtain, the current device status information can be entirely opening, closing, opening 60%, etc. As shown in FIG. 3, the control component displays a device status entrance corresponding to the target device therein; if a user clicks “status”, a trigger operation for the device status entrance is generated, thus the current device status information corresponding to the target device is shown to facilitate viewing the current status of the target device.

In one embodiment, the method further includes the following step: dynamically updating the device status information in the device control interface when identifying that the device status information of the target device generates change based on an image collected in the target scenario.

Among them, it is possible to identify whether the device status of the target device generate change based on an image collected in the target scenario, for example, when a smart curtain changes from entirely opening to opening 60%, based on an image collected in the target scenario, it is possible to identify status change of the smart curtain, and thus dynamically update the device status information in the device control interface.

The present application further provides an application scenario, the application scenario applies the above device control method. Specifically, application of the device control method in the application scenario is as follows.

A user in a company, when wanting to control air conditioning at home to start working, can enter a home application in a terminal, then enter a device control interface, and display a scenario picture in the device control interface. Control components used to control target devices are displayed at positions where the target devices are located in the scenario picture, for example, a control button is displayed beside the air conditioning, and beside other devices respective control components will also be displayed. Thus, multiple target devices and corresponding control components are presented through the device control interface, giving users “controllable as visible” experience. At this point, a user can complete control for the air conditioning by clicking the control button for operating the air conditioning in the device control interface, the operation process is more intuitive and simple to understand.

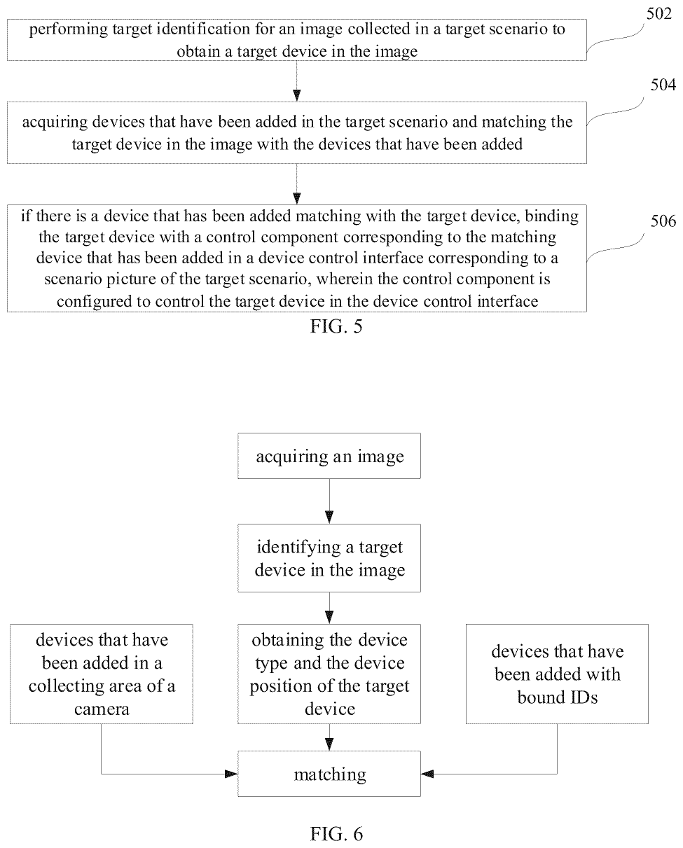

FIG. 5 is a schematic flow chart of a device control method in another embodiment. As shown in FIG. 5, a device control method can be applied in the server, terminal, or gateway as shown in FIG. 1, and includes:

Step 502, performing target identification for an image collected in a target scenario to obtain a target device in the image.

Among them, the target scenario refers to a scenario where device control is required, which can specifically be an environment with target devices mounted, for example, it can be a bedroom, a living room, overall layout, an office, and other environments. The target devices refer to devices in the target scenario that can access a network for communication and control, and can specifically be smart devices mounted in the target scenario, for example, they can include smart home devices, such as cameras, smart lights, smart curtains, smart air conditioning, smart TVs, door and window sensors, and other devices.

Among them, images in the target scenario are collected by an image collecting module, the image collecting module, for example, is a camera that has been accessed the local area network where the gateway is located, which can be mounted in a living room, a bedrooms, a balcony, and other locations, and can capture images containing the target device. Taking sending images to the terminal as an example, the images collected by the image collecting module can be sent to the terminal through the server. When the terminal accesses the local area network where the gateway is located, the images collected by the image collecting module can also be directly sent to the terminal through the gateway.

Step 504, acquiring devices that have been added in the target scenario and matching the target device in the image with the devices that have been added.

Among them, the devices that have been added are smart devices that are mounted in the target scenario and have already connected to the network, for example, they can include smart home devices, such as cameras, smart lights, smart curtains, smart air conditioning, smart TVs, door and window sensors, and other devices. The devices that have been added are bound in advance with the control components, for example, a smart light has already connected to the network is bound with a smart switch, the smart light can be controlled through the smart switch. Thus target identification is performed for the image collected in the target scenario, after obtaining the target device in the image, at first, the target device in the image is matched with the devices that have been added, so as to determine a device that has been added corresponding to the target device in the image.

Step 506, if there is a device that has been added matching with the target device, binding the target device with a control component corresponding to the matching device that has been added in a device control interface corresponding to a scenario picture of the target scenario, wherein the control component is configured to control the target device in the device control interface.

Among them, the devices that have been added are bound in advance with the control components; when there is a device that has been added matching with the target device, the target device is bound with a control component corresponding to the matching device that has been added in a device control interface corresponding to a scenario picture of the target scenario, thereby forming control relationship, such that the control component can control the target device in the device control interface.

In an embodiment, the step 502, performing target identification for an image collected in a target scenario to obtain a target device in the image includes: acquiring the image collected in the target scenario; and performing target identification for the image to obtain a device type corresponding to the target device in the image and a device position of the target device in the target scenario.

Among them, steps of collecting an image in the target scenario can include: monitoring whether an image picture changes; if the image picture does not change, collecting the image; if the image picture changes, continuing to collect the image when the image picture is still. When a position and an angle of the image collecting module remain unchanged, it can be considered that the image picture does not change. Optionally, if the image picture does not change, a frequency of collecting the image and a frequency of monitoring whether the image picture changes can be reduced.

The device type refers to a type of the target device, for example, it can be a light, a curtain, an air conditioning, a door, etc. The device position of the target device in the target scenario refers to a mounting position of the target device in the target scenario, for example, it can be a living room, a bedroom, an office, etc.

Furthermore, performing target identification for the image can further obtain a position of the target device in the image; and based on the position of the target device in the image, a position of displaying the target device in the scenario picture can be determined. Thus, in the aforementioned embodiments, displaying positions of the control components can be associated with displaying positions of the target devices in the scenario picture.

In an embodiment, the image collecting module, after collecting an image, can perform identification for a target device in the image locally in image collecting module. Alternatively, the image collecting module, after collecting an image, can send the image to the server or the terminal, the server or the terminal performs identification for the target device in the image.

In an embodiment, the step 504, acquiring devices that have been added in the target scenario and matching the target device in the image with the devices that have been added includes: acquiring device types and device positions of the devices that have been added in the target scenario; and matching the device type and the device position of the target device with the device types and the device positions of the devices that have been added.

In an embodiment, the matching the device type and the device position of the target device with the device types and the device positions of the devices that have been added includes: in the devices that have been added, determining target added devices of which device positions match with the device position of the target device, and in the target added devices, determining a device of which the device type matches with the device type of the target device as the device that has been added matching with the target device.

Among them, after acquiring the device type and the device position of the target device, the devices that have been added are matched based on the device type and the device position, and binding for the control components is performed. Referring to FIG. 6, after acquiring the image and performing identification for the target device in the image to obtain the device type and the device position of the target device, devices that have been added in a collecting area of a camera are acquired; alternatively, devices that have been added with bound IDs are acquired, the device type and the device position of the target device are matched with the device types and the device positions of the devices that have been added, a matched device that has been added is determined, and thus the target device is bound with a control component corresponding to the matched device that has been added.

During actual implementation, if the image collecting module or the devices that have been added have performed room division when being connected to a network, it is possible to acquire devices that have been added in a collecting area of the image collecting module, that is, all devices that have been added in the room. If the image collecting module or the devices that have been added have not performed room division when being connected to a network, devices that have been added with bound IDs, that is, all devices that have been added and connected to a network in the current space or room, are directly acquired.

In an embodiment, after the step of in the target added devices, determining a device of which the device type matches with the device type of the target device as the device that has been added matching with the target device, the method can further include: acquiring the number of the matched device that has been added; if the number of the matched device that has been added is more than one, showing a device selection interface, and displaying matched devices that have been added in the shown device selection interface for selection; and according to a selection operation received by the device selection interface, binding the target device with a control component corresponding to a device that has been added corresponding to the selection operation.

Among them, if the number of the matched device that has been added is one, it is possible to directly bind the target device and a control component of the corresponding device that has been added; for example, if it is identified that there is a curtain in the target scenario, at the same time, there is only one curtain in the devices that have been added in the target scenario, the matching is unique, by controlling action instructions of a curtain motor corresponding to the curtain, control for the curtain can be implemented. If the number of the matched device that has been added is more than one, it is possible to let users to join selection and determination; for example, it is identified that there is one desk lamp in the target scenario, but there are two desk lamps in the devices that have been added in the target scenario; at this point, matching cannot be directly completed, a selection interface can be output, a matched desk lamp is selected and determined by a user, and thus the identified desk lamp is bound with a control component of a desk lamp selected by the user.

In an embodiment, the target device in the image is obtained by performing identification through a trained deep learning model.

Among them, the trained deep learning model is adopted to identify the target device in the image. At first, at least one frame of image is acquired, then pre-processing, such as normalization, scaling, etc., is performed for the image; thus the pre-processed image is input into the trained deep learning model to perform identification for the target device, the identification result of the model includes the device type, a displayed area in the image, reliability, a bbox (Bounding box), and so on of the target device; through the reliability, output device type and displayed area in the image of the target device are finally selected.

In an embodiment, the trained deep learning model is obtained through model training steps; the model training steps include: acquiring sample images collected in multiple kinds of real environments, wherein the sample images include sample labels labeled with positions and types of sample target devices; performing target identification for the sample images through an initial deep learning model to obtain an identification result of a sample target device in the sample images, wherein the identification result includes a position and a type of the sample target device; and adjusting parameters of the initial deep learning model based on difference between the identification result and the sample labels and continuing to train, and stop training when training conditions are met to obtain the trained deep learning model.

Among them, the multiple kinds of real environments refer to real environments in multiple kinds of collecting conditions, the collection conditions include at least one of a house type, a room type, a placing position of collection equipment, lighting, and a degree of sheltering the target device. The room type includes bedroom, living room, bathroom, kitchen, balcony, etc. Real environment images can be obtained by crawling on purchase or rental websites or collecting images after actively arranging home environments. By selecting the real environment images collected in multiple kinds of collecting conditions, it is possible to obtain different morphological rules of target devices in different conditions, such as house types, room types, placing positions of collection equipment, lighting, degrees of sheltering target devices, and so on, such that identified objects are not limited to specific product appearances and specific scenarios. Identification accuracy and the range of devices that can be identified can be improved, although the target devices are replaced or added, it is also possible to ensure smooth progress of device identification and reduce a missing rate of detection.

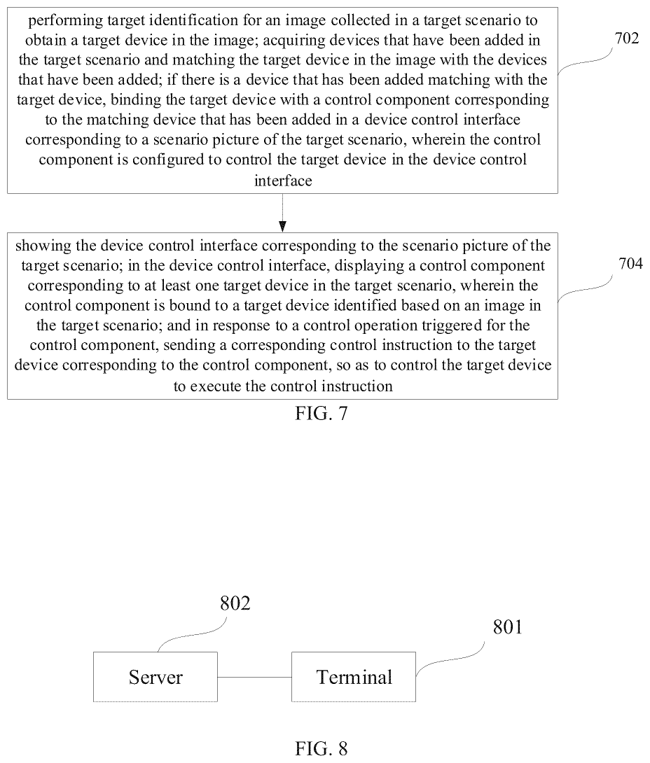

FIG. 7 is a schematic flow chart of a device control method in further another embodiment. As shown in FIG. 7, a device control method includes:

Step 702, performing target identification for an image collected in a target scenario to obtain a target device in the image; acquiring devices that have been added in the target scenario and matching the target device in the image with the devices that have been added; if there is a device that has been added matching with the target device, binding the target device with a control component corresponding to the matching device that has been added in a device control interface corresponding to a scenario picture of the target scenario, wherein the control component is configured to control the target device in the device control interface.

Step 704, showing the device control interface corresponding to the scenario picture of the target scenario; in the device control interface, displaying a control component corresponding to at least one target device in the target scenario, wherein the control component is bound to a target device identified based on an image in the target scenario; and in response to a control operation triggered for the control component, sending a corresponding control instruction to the target device corresponding to the control component, so as to control the target device to execute the control instruction.

Regarding specific limitations of the step 702 and the step 704, please refer to the limitations of device control methods in the embodiments in the above description.

The present application further provides an application scenario, this application scenario applies aforesaid device control method. Specifically, application of the device control method in this application scenario is as follows.

A user in a company, when wanting to open a curtain in a living room, can enter a home application in the terminal, and then enter an interface for device control. At this time, the image collecting module collects an image and sends it to the server, the server perform identification for the image, and sends device types of target devices in the image and displaying positions thereof in a scenario picture to the terminal. Thus, the device control interface displays the scenario picture of the living room therein, and displays control components for controlling the target devices in displaying positions of the target devices. Among them, the target devices in the device control interface will include the curtain and other devices, a control button for a curtain motor is displayed beside the curtain, and respective control components will also be displayed beside other devices, thus, multiple target devices and corresponding control components are presented through the device control interface, giving the user “controllable as visible” experience. At this time, the user, by clicking to operate the control button for the curtain motor in the device control interface, can open the curtain. The operation process is more intuitive and simple to understand.

It should be understood that although the steps in the flowcharts of FIG. 2 and FIGS. 5-7 are displayed sequentially according to indication of the arrows, these steps are not necessarily executed sequentially in the order indicated by the arrows. Unless explicitly stated in this specification, there is no strict sequential restriction on the execution of these steps, and these steps can be executed in other orders. Moreover, at least some of the steps in FIG. 2 and FIGS. 5-7 may include multiple sub-steps or multiple stages, these sub-steps or stages may not necessarily be executed and completed at the same time, but may be executed at different times. The execution order of these sub-steps or stages is not necessarily be sequentially performing, but may be executed in turn or alternately with at least a part of other steps or sub-steps or stages of other steps.

FIG. 8 is a structural block diagram of a device control system in an embodiment. As shown in FIG. 8, a device control system includes a terminal 801 and a server 802.

The server 802 is configured to: perform target identification for an image collected in a target scenario to obtain a target device in the image; acquire devices that have been added in the target scenario and match the target device in the image with the devices that have been added; if there is a device that has been added matching with the target device, bind the target device with a control component corresponding to the matching device that has been added in a device control interface corresponding to a scenario picture of the target scenario, wherein the control component is configured to control the target device in the device control interface.

The terminal 801 is configured to: show the device control interface corresponding to the scenario picture of the target scenario; in the device control interface, display a control component corresponding to at least one target device in the target scenario, wherein the control component is bound to a target device identified based on an image in the target scenario; and in response to a control operation triggered for the control component, send a corresponding control instruction to the target device corresponding to the control component, so as to control the target device to execute the control instruction.

Regarding specific limitations of the terminal 801 and the server 802, please refer to the limitations of device control methods in the aforementioned embodiments.

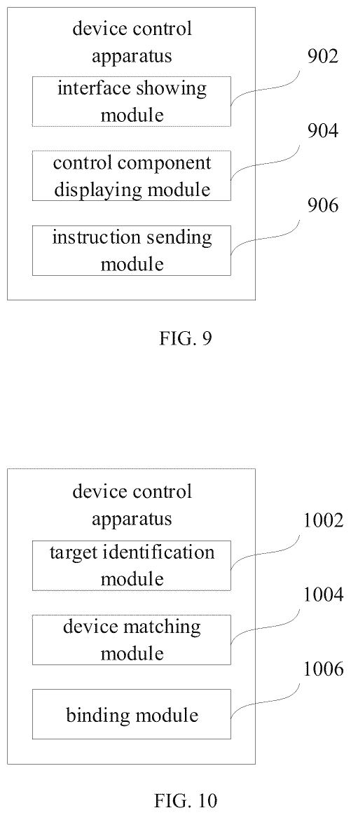

FIG. 9 is a structural block diagram of a device control apparatus in an embodiment. As shown in FIG. 9, a device control apparatus includes: an interface showing module 902 configured to show a device control interface corresponding to a scenario picture of a target scenario; a control component displaying module 904 configured to: in the device control interface, display a control component corresponding to at least one target device in the target scenario, wherein the control component is bound to a target device identified based on an image in the target scenario; and an instruction sending module 906 configured to: in response to a control operation triggered for the control component, send a corresponding control instruction to the target device corresponding to the control component, so as to control the target device to execute the control instruction.

In an embodiment thereof, the control component displaying module 904 includes: a first displaying unit configured to display a scenario picture corresponding to a real target scenario in the device control interface; and a second displaying unit configured to display, in the scenario picture, a control component corresponding to at least one target device in the real target scenario.

In an embodiment thereof, the apparatus further includes: a device status entrance displaying module configured to display a device status entrance corresponding to the target device in the control component; and a device status information displaying module configured to show current device status information corresponding to the target device in response to a trigger operation for the device status entrance.

In an embodiment thereof, the apparatus further includes: a device status information updating module configured to dynamically update the device status information in the device control interface when identifying that the device status information of the target device generates change based on an image collected in the target scenario.

In an embodiment thereof, the device control interface includes a scenario picture of a two-dimensional target scenario or a scenario picture of a three-dimensional target scenario corresponding to a real scenario.

Regarding specific limitations of the device control apparatus in this embodiment, please refer to the limitations of device control methods in the aforementioned embodiments. The modules in the above device control apparatus can be fully or partially implemented through software, hardware, and combination thereof. The above modules can be embedded in or independent of a processor in a computer device in the form of hardware, and can also be stored in a memory of the computer device in the form of software for the processor to call and execute operations corresponding to the above modules.

FIG. 10 is a structural block diagram of a device control apparatus in another embodiment. As shown in FIG. 10, a device control apparatus includes: a target identification module 1002 configured to perform target identification for an image collected in a target scenario to obtain a target device in the image; a device matching module 1004 configured to acquire devices that have been added in the target scenario and match the target device in the image with the devices that have been added; and a binding module 1006 configured to: if there is a device that has been added matching with the target device, bind the target device with a control component corresponding to the matching device that has been added in a device control interface corresponding to a scenario picture of the target scenario, wherein the control component is configured to control the target device in the device control interface.

In an embodiment thereof, the target identification module 1002 includes: an image acquiring unit configured to acquire the image collected in the target scenario; and a target identification unit configured to perform target identification for the image to obtain a device type corresponding to the target device in the image and a device position of the target device in the target scenario; the device matching module 1004 includes: a device information acquiring unit configured to acquire device types and device positions of the devices that have been added in the target scenario; and a device matching unit configured to match the device type and the device position of the target device with the device types and the device positions of the devices that have been added.

In an embodiment thereof, the device matching unit is configured to: in the devices that have been added, determine target added devices of which device positions match with the device position of the target device; and in the target added devices, determine a device of which the device type matches with the device type of the target device as the device that has been added matching with the target device.

In an embodiment thereof, the target device in the image is obtained by performing identification through a trained deep learning model; the trained deep learning model is obtained through model training steps, the apparatus includes a model training module, and the model training module includes: a sample image acquiring unit configured to acquire sample images collected in multiple kinds of real environments, wherein the sample images include sample labels labeled with positions and types of sample target devices; a target identification unit configured to perform target identification for the sample images through an initial deep learning model to obtain an identification result of a sample target device in the sample images, wherein the identification result includes a position and a type of the sample target device; and a training unit configured to adjust parameters of the initial deep learning model based on difference between the identification result and the sample labels and continue to train, and stop training when training conditions are met to obtain the trained deep learning model.

Regarding specific limitations of the device control apparatus in this embodiment, please refer to the limitations of device control methods in the aforementioned embodiments. The modules in the above device control apparatus can be fully or partially implemented through software, hardware, and combination thereof. The above modules can be embedded in or independent of a processor in a computer device in the form of hardware, and can also be stored in a memory of the computer device in the form of software for the processor to call and execute operations corresponding to the above modules.

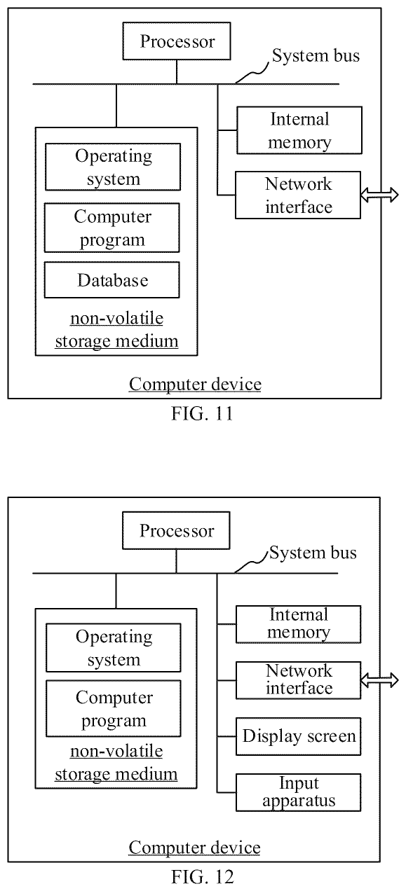

In an embodiment, an electronic device is provided, the electronic device can be a server, an internal structural diagram thereof can be as shown in FIG. 11. The electronic device includes a processor, a memory, a network interface, and a database connected through a system bus. Among them, the processor of the electronic device is used to provide computing and control capabilities. The memory of this electronic device includes non-volatile storage media and an internal memory. The non-volatile computer readable storage medium stores operating systems, computer readable instructions, and databases. The internal memory provides an environment for operation of the operating systems and the computer readable instructions in the non-volatile computer readable storage medium. The database of this electronic device is used to store device control data. The network interface of the electronic device is used to communicate with external terminals through network connections. The computer readable instructions, when being executed by the processor, implement a device control method.

Technicians in this field can understand that the structure shown in FIG. 11 is only a block diagram of a portion of a structure related to the solution of the present application and does not constitute limitation on the electronic device on which the solution of the present application is applied. The specific electronic device may include more or fewer components than shown in the figure, or combinations of certain components, or have different component arrangements.

In an embodiment, an electronic device is provided, the electronic device can be a terminal, an internal structural diagram thereof can be as shown in FIG. 12. The electronic device includes a processor, a memory, a network interface, a display screen, and an input apparatus connected through a system bus. Among them, the processor of the electronic device is used to provide computing and control capabilities. The memory of this electronic device includes non-volatile computer readable storage media and an internal memory. The non-volatile computer readable storage medium stores operating systems and computer readable instructions. The internal memory provides an environment for operation of the operating systems and the computer readable instructions in the non-volatile computer readable storage medium. The network interface of the electronic device is used to communicate with external terminals through network connections. The computer readable instructions, when being executed by the processor, implement a device control method. The display screen of the electronic device can be a liquid crystal display screen or an electronic ink display screen. The input apparatus of the electronic device can be a touch layer covering on the display screen, and can also be a button, a trackball, or a touch pad arranged on an outer casing of the electronic device, and can also be an externally connected keyboard, touch pad, mouse, etc.

Technicians in this field can understand that the structure shown in FIG. 12 is only a block diagram of a portion of a structure related to the solution of the present application and does not constitute limitation on the electronic device on which the solution of the present application is applied. The specific electronic device may include more or fewer components than shown in the figure, or combinations of certain components, or have different component arrangements.

In an embodiment, an electronic device is provided, it includes a memory and a processor, the memory stores computer readable instructions, and the processor implements the steps of aforementioned method embodiments when executing the computer readable instructions.

In an embodiment, an electronic device is provided, it includes a memory and a processor, the memory stores computer readable instructions, and the processor implements the steps of aforementioned method embodiments when executing the computer readable instructions.

In an embodiment, a computer readable instruction product or computer readable instruction is provided, the computer readable instruction product or computer readable instruction includes computer instructions, the computer instructions are stored in a computer readable storage medium. A processor of a computer device reads the computer instructions from the computer readable storage medium, and the processor executes the computer instructions to make the computer device execute the steps of the aforementioned method embodiments.

One or more non-volatile computer readable storage medium stores computer readable instructions, the computer readable instruction, when being executed by one or more processor, make the one or more processor to execute the steps of the aforementioned method embodiments. Regarding specific limitations of the steps, please refer to the limitations of device control methods in the aforementioned method embodiments.

In an embodiment, a computer readable instruction product or computer readable instruction is provided, the computer readable instruction product or computer readable instruction includes computer instructions, the computer instructions are stored in a computer readable storage medium. A processor of a computer device reads the computer instructions from the computer readable storage medium, and the processor executes the computer instructions to make the computer device execute the steps of the aforementioned method embodiments.

Ordinary technical personnel in this field can understand that implementing all or some of the processes in the methods of the above embodiments can be accomplished by instructing relevant hardware using computer readable instructions. The computer readable instructions can be stored in a non-volatile computer readable storage medium, and the computer readable instructions may include processes of the embodiments of the above methods when being executed. Among them, any reference to memory, storage, databases, or other media used in the various embodiments provided by the present application may include non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. As explanation rather than limitation, RAM can be obtained in various forms, such as static RAM (SRAM), dynamic RAM (DRAM), synchronous DRAM (SDRAM), dual data rate SDRAM (DDRSDRAM), enhanced SDRAM (ESDRAM), synchronous link (Synlink) DRAM (SLDRAM), memory bus (Rambus) direct RAM (RDRAM), direct memory bus dynamic RAM (DRDRAM), memory bus dynamic RAM (RDRAM), and so on.

The various technical features of the above embodiments can be combined in any way. In order to make the description be concise, all possible combinations of the various technical features in the above embodiments have not been described. However, as long as there is no contradiction in the combinations of these technical features, they should be considered as the scope of this specification.

The above described embodiments only express several implementation manners of the present application, and their description is more specific and detailed, but cannot be understood as limitation to the patent scope of the present invention. It should be pointed out that for ordinary technical personnel in this field, several modifications and improvements can be further made without departing from the concept of the present application, all of them fall within the protection scope of the present application. Therefore, the patent protection scope of the present application shall be based on the attached claims.

### INDUSTRIAL APPLICABILITY

A device control interface corresponding to a scenario picture of a target scenario is shown; in the device control interface, a control component corresponding to at least one target device in the target scenario is displayed, wherein the control component is bound to a target device identified in an image based on the target scenario; and in response to a control operation triggered for the control component, a corresponding control instruction is sent to the target device corresponding to the control component, so as to control the target device to execute the control instruction. In this way, by showing the device control interface corresponding to the scenario picture of the target scenario and displaying the control component bound to the target device in the interface, “controllable as visible” for smart devices in the scenario picture is realized, users do not need to operate control interfaces for selecting smart devices multiple times, operation is more convenient, and users' experience is greatly improved.

1. A device control method executed by an electronic device, wherein the method comprises:
showing a device control interface corresponding to a scenario picture of a target scenario;
in the device control interface, displaying a control component corresponding to at least one target device in the target scenario, wherein the control component is bound to a target device identified in an image based on the target scenario; and
in response to a control operation triggered for the control component, sending a corresponding control instruction to the target device corresponding to the control component, so as to control the target device to execute the control instruction.

2. The method according to claim 1, wherein the in the device control interface, displaying a control component corresponding to at least one target device in the target scenario comprises:
displaying a scenario picture corresponding to a real target scenario in the device control interface; and
displaying, in the scenario picture, a control component corresponding to at least one target device in the real target scenario.

3. The method according to claim 1, wherein the method further comprises:
displaying a device status entrance corresponding to the target device in the control component; and
showing current device status information corresponding to the target device in response to a trigger operation for the device status entrance.

4. The method according to claim 3, wherein the method further comprises:
dynamically updating the device status information in the device control interface when identifying that the device status information of the target device generates change based on an image collected in the target scenario.

5. The method according to claim 1, wherein the device control interface comprises a two-dimensional scenario picture or a three-dimensional scenario picture corresponding to a real target scenario.

6. A device control method executed by an electronic device, wherein the method comprises:
performing target identification for an image collected in a target scenario to obtain a target device in the image;
acquiring devices that have been added in the target scenario and matching the target device in the image with the devices that have been added; and
if there is a device that has been added matching with the target device, binding the target device with a control component corresponding to the matching device that has been added in a device control interface corresponding to a scenario picture of the target scenario, wherein the control component is configured to control the target device in the device control interface.

7. The method according to claim 6, wherein the performing target identification for an image collected in a target scenario to obtain a target device in the image comprises:
acquiring the image collected in the target scenario; and
performing target identification for the image to obtain a device type corresponding to the target device in the image and a device position of the target device in the target scenario;
the acquiring devices that have been added in the target scenario and matching the target device in the image with the devices that have been added comprises:
acquiring device types and device positions of the devices that have been added in the target scenario; and
matching the device type and the device position of the target device with the device types and the device positions of the devices that have been added.

8. The method according to claim 7, wherein the matching the device type and the device position of the target device with the device types and the device positions of the devices that have been added comprises:
in the devices that have been added, determining target added devices of which device positions match with the device position of the target device; and
in the target added devices, determining a device of which the device type matches with the device type of the target device as the device that has been added matching with the target device.

9. The method according to claim 6, wherein the target device in the image is obtained by performing identification through a trained deep learning model; the trained deep learning model is obtained through model training steps; the model training steps comprise:
acquiring sample images collected in multiple kinds of real environments, wherein the sample images include sample labels labeled with positions and types of sample target devices;
performing target identification for the sample images through an initial deep learning model to obtain an identification result of a sample target device in the sample images, wherein the identification result includes a position and a type of the sample target device; and
adjusting parameters of the initial deep learning model based on difference between the identification result and the sample labels and continuing to train, and stop training when training conditions are met to obtain the trained deep learning model.

10. A device control system comprising a terminal and a server;
wherein the server is configured to: perform target identification for an image collected in a target scenario to obtain a target device in the image; acquire devices that have been added in the target scenario and match the target device in the image with the devices that have been added; if there is a device that has been added matching with the target device, bind the target device with a control component corresponding to the matching device that has been added in a device control interface corresponding to a scenario picture of the target scenario, wherein the control component is configured to control the target device in the device control interface;
the terminal is configured to: show the device control interface corresponding to the scenario picture of the target scenario; in the device control interface, display a control component corresponding to at least one target device in the target scenario, wherein the control component is bound to a target device identified based on an image in the target scenario; and in response to a control operation triggered for the control component, send a corresponding control instruction to the target device corresponding to the control component, so as to control the target device to execute the control instruction.

11-20. (canceled)

21. The method according to claim 1, wherein the control component is stacked and displayed on the at least one target device corresponding to the control component, or displayed beside the at least one target device corresponding to the control component.

22. The method according to claim 1, wherein the scenario picture comprises a real picture or a virtual picture reflecting the target scenario.

23. The method according to claim 22, wherein the real picture is obtained based on images collected by an image collecting module.

24. The method according to claim 22, wherein the virtual picture is obtained by modeling for the target scenario.

25. The method according to claim 1, wherein the control component comprises at least one of a physical control component and a virtual control component, and is configured to directly implement status display and/or functional control for the at least one target device corresponding to the control component in the device control interface.

26. The method according to claim 7, further comprising:
monitoring whether an image picture of the image changes;
if the image picture does not change, reducing a frequency of collecting the image.

27. The method according to claim 6, wherein the performing target identification for an image collected in a target scenario to obtain a target device in the image comprises:
acquiring the image collected in the target scenario; and
performing target identification for the image to obtain device types corresponding to a plurality of target devices in the image and device positions of the plurality of target devices in the target scenario;
the acquiring devices that have been added in the target scenario and matching the target device in the image with the devices that have been added comprises:
acquiring device types and device positions of the devices that have been added in the target scenario; and
respectively matching the device types and the device positions of the plurality of target device with the device types and the device positions of the devices that have been added.

28. The method according to claim 6, further comprising:
simultaneously displaying a plurality of control components respectively corresponding to the plurality of target devices in the device control interface, wherein each of the plurality of control components is stacked and displayed on a target device corresponding to the control component, or displayed beside a target device corresponding to the control component.

29. The method according to claim 6, wherein the control component comprises at least one of a physical control component and a virtual control component, and is configured to directly implement status display and/or functional control for the target device corresponding to the control component in the device control interface.

30. The method according to claim 6, further comprising:
acquiring the number of the device that has been added matching with the target device;
if the number of the device that has been added matching with the target device is more than one, showing a device selection interface, and displaying devices that have been added matching with the target device in the device selection interface; and
according to a selection operation received by the device selection interface, binding the target device with a control component corresponding to a device that has been added corresponding to the selection operation.
